(19) United States
(12) Patent Application Publication
(10) Pub. No.: US 2026/0104064 A1
(43) Pub. Date: Apr. 16, 2026

(54) Position Sensing System with Multiple Resolving Nodes

(71) Applicant: Parker-Hannifin Corporation, Cleveland, OH (US)

(72) Inventors: Daniel R. Van de Water, Morton, IL (US); Timothy A. Christensen, Mechanicsburg, IL (US); Steven A. Robison, Vandalia, MI (US); David J. Bibelhausen, Maineville, OH (US)

(21) Appl. No.: 19/342,770

(22) Filed: Sep. 29, 2025

Related U.S. Application Data
(60) Provisional application No. 63/706,856, filed on Oct. 14, 2024.

(51) Int. Cl. F15B 15/28; G01D 5/16

(52) U.S. Cl. CPC F15B 15/2861; G01D 5/16; G01D 2205/18

(57) ABSTRACT

An example position sensing system includes: a cylinder actuator having a cylinder and a piston that is movable within the cylinder, wherein a range of movement of the piston is divided into a set of ranges; a magnet that is coupled to the piston; and a plurality of sensor nodes mounted external to the cylinder, wherein each sensor node of the plurality of sensor nodes is assigned a respective range of the set of ranges, and wherein each sensor node provides position information indicating a position of the magnet when the magnet is in the respective range assigned to the sensor node.

### CROSS REFERENCE TO RELATED APPLICATION

The present application claims priority to U.S. Provisional Application No. 63/706,856 filed on Oct. 14, 2024, the entire contents of which are herein incorporated by reference as if fully set forth in this description.

### BACKGROUND

A hydraulic or pneumatic cylinder actuator typically includes a piston that is movable within a cylinder. Control of the actuator may involve controlling forces applied by the piston with high precision. It may be desirable to obtain accurate position information of the piston to control the applied forces with such high precision.

Some applications involve the use of a Linear Variable Differential Transformer (LVDT), which is a device that converts an object's linear motion into an electrical signal. However, LVDTs tend to be costly and may require boring of a piston rod, which adds to complexity and increase manufacturing cost.

Some position measurement systems are based on magnetic fields that provide only a binary measurement of position (e.g., an indication of whether the object is to the left or the right of the sensor), and do not provide a continuous measurement of position. In other systems, a sensor is used to measure position of a magnet attached to a moving object. However, in such systems, the size of the sensor increases with the increase in the range of measurement of the sensor. For example, if it is desired to measure the position of a piston with a range of motion of 500 millimeter (mm), the length of the sensor should be at least 500 mm, which might not be feasible in some applications.

It may thus be desirable to have a position sensing system that can determine piston position accurately while alleviating the issues above. It is with respect to these and other considerations that the disclosure made herein is presented.

### SUMMARY

The present disclosure describes implementations that relate to a position sensing system with multiple resolving sensor nodes.

In a first example implementation, the present disclosure describes a position sensing system including: a cylinder actuator having a cylinder and a piston that is movable within the cylinder, wherein a range of movement of the piston is divided into a set of ranges; a magnet that is coupled to the piston; and a plurality of sensor nodes mounted external to the cylinder, wherein each sensor node of the plurality of sensor nodes is assigned a respective range of the set of ranges, and wherein each sensor node provides position information indicating a position of the magnet when the magnet is in the respective range assigned to the sensor node.

In a second example implementation, the present disclosure also describes a method of operating the position sensing system of the first example implementation.

In a third example implementation, the present disclosure also describes a cylinder actuator including the position sensing system of the first example implementation.

In a fourth example implementation, the present disclosure also describes a fluid system including the cylinder actuator of the third example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a cylinder actuator with a position sensing system, according to an example implementation.

FIG. 2A is a block diagram of a position sensing system, according to an example implementation.

FIG. 2B is a block diagram of a position sensing system with overlapping ranges of detection, according to an example implementation.

FIG. 3 is a block diagram for a communication configuration for the position sensing system of FIGS. 2A-2B, according to an example implementation.

FIG. 4 is a block diagram of a sensor node, according to an example implementation.

FIG. 5 is a flowchart of a method for operating the position sensing system of FIG. 1, according to an example implementation.

FIG. 6 is a block diagram of a position sensing system having a fixed source of magnetic field and a movable sensor system, according to an example implementation.

FIG. 7 illustrates a cylinder actuator driving an implement with a sensor system coupled to the implement, according to an example implementation.

FIG. 8 illustrates a cylinder actuator driving an implement with a sensor system coupled to the implement and a source of magnetic field disposed external the cylinder actuator, according to an example implementation.

### DETAILED DESCRIPTION

Within examples, disclosed herein are a position sensing system (PSS), a cylinder actuator having the PSS, and a method to resolve position of a magnet or magnets using multiple sensor nodes. One of the sensor nodes operates as a primary or master sensor node, while the others are subordinate or secondary resolving sensor nodes.

In an example, the range of movement of a piston (to which the magnet is attached) is divided into a set of ranges (or subranges), one range for each sensor node. Each sensor node resolves/determines the position of the magnet when the magnet is within the assigned position detection range of the sensor node. The sensor nodes are linked to a master sensor node, which continuously resolves the sensor nodes'information and reports a position within each sensor node's detection range (e.g., to a controller of the cylinder actuator).

In an example, each sensor node has a Universal Synchronous/Asynchronous Receive Transmit (USART) channel dedicated to communication with one Transmission (Tx) line connected to the Receive (Rx) line of a subsequent sensor node. The last sensor node's Tx line is connected to the first sensor node to complete a daisy-chain circuit flood network (e.g., a configuration where multiple sensor nodes are connected in a sequence or daisy chain and use a network flooding protocol to distribute data).

In some examples, each sensor node has one or more dedicated Direct Memory Access (DMA) hardware devices, features, or controllers that allow for simultaneous processing of fixed length communication messages passed between sensor nodes. “Simultaneous processing” is used herein to indicate processing incoming message (e.g., from a preceding sensor node) and outgoing messages (to a subsequent sensor node) at substantially the same time. The fixed length communication may contain a header frame that describes when the message starts and what the purpose of the message is, supporting a variable message format between sensor nodes.

Advantageously, DMA controllers allow for accessing the main memory of a sensor node directly, bypassing a processor or central processing unit of the sensor node to transfer (receive or transmit) data. This can be accomplished using a dedicated DMA controller, which offloads data transfer tasks from the processor, thereby reducing processor overhead and improving performance and responsiveness of the sensor node.

As such, DMA controllers may enable high-speed data processing, such as moving large blocks of data between sensor nodes. In an example, two DMA controller may be used, one for receiving date from a preceding sensor node, and another for transmitting data to a subsequent sensor node. This allows for simultaneous communication with a preceding sensor node and a subsequent sensor node with no or minimal involvement from a processor of the sensor node.

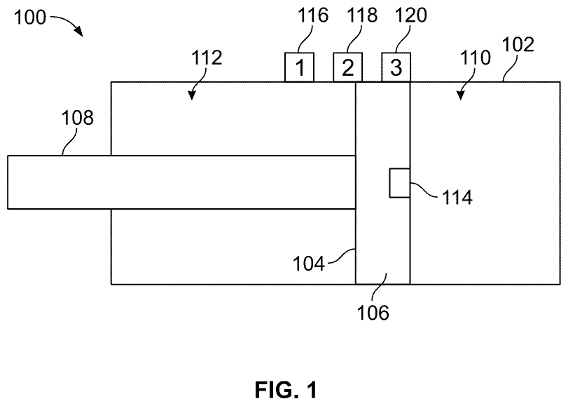

FIG. 1 illustrates a cylinder actuator 100 with a position sensing system, according to an example implementation. The cylinder actuator 100 has a cylinder 102 and a piston 104 that is slidably accommodated (axially movable) in the cylinder 102. The piston 104 is configured to move in a linear direction in the cylinder 102.

The piston 104 includes a piston head 106 and a rod 108 extending from the piston head 106 along a central longitudinal axis direction of the cylinder 102. The rod 108 can be coupled to a load that represents, for example, an implement of a machine and any forces applied thereto. The piston head 106 divides the internal space of the cylinder 102 into a first chamber 110 and a second chamber 112.

The first chamber 110 can be referred to as head-side chamber as the fluid therein interacts with the piston head 106, and the second chamber 112 can be referred to as rod-side chamber as the rod 108 is disposed partially therein. If fluid (e.g., hydraulic fluid or gas) is provided to the first chamber 110, the piston 104 may extend (e.g., move to the left in FIG. 1) while fluid is discharged from the second chamber 112. Conversely, if fluid is provided to the second chamber 112, the piston 104 may retract (e.g., move to the right in FIG. 1) while fluid is discharged from the first chamber 110.

In many applications, it may be desirable to determine the position of the piston 104 with high accuracy. This may allow a controller of the cylinder actuator 100 to control fluid flow and pressure level to apply a specific force via the piston 104, for example.

As such, the cylinder actuator 100 may have a position sensing system (PSS) that facilitates determining the position of the piston 104 with high accuracy. For example, the PSS includes one or more magnets attached to the piston 104. For instance, the PSS may include a source of magnetic field such as a magnet 114 attached or embedded in the piston head 106 as shown in FIG. 1. However, the magnet 114 can be embedded or attached to other portions of the piston 104 (e.g., to the piston rod 108).

Further, the PSS may also include a plurality of sensor nodes mounted external to the cylinder 102 and spaced apart along at least a portion of a length of the cylinder 102. For example, the PSS may include a first sensor node 116, a second sensor node 118, and a third sensor node 120 mounted externally or attached to the cylinder 102. Although three sensor nodes are shown, more or fewer sensor nodes may be used depending on a stroke or range of movement of the piston 104.

In an example, the sensor nodes 116-120 may each include one or more magnetic sensors. An example magnetic sensor is an anisotropic magnetoresistive (AMR) sensor. An AMR sensor may be made up of a thin film of alloy on a glass or silicon board. Such AMR sensor measures the position of the piston 104 by interacting with the magnet 114 and measuring the angle of a magnetic field by detecting changes in an electrical resistance of the alloy material.

Particularly, the AMR sensor may operate by interacting with the magnet 114 where the magnet 114 generates an external magnetic field that is applied in a direction perpendicular to the axial direction of the cylinder 102 or the piston 104. The electric resistance value of the alloy material of the AMR sensor changes according to the magnetic field strength or intensity. AMR sensors utilize this effect to determine the position of the piston 104. Other types of magnetic sensors can be used (e.g., Hall-effect sensors, Reed sensors, Giant Magnetoresistive (GMR) sensors, Tunnel Magnetoresistive (TMR) sensors, or Fluxgate magnetometers).

Notably and advantageously, the PSS uses multiple sensor nodes (e.g., the sensor nodes 116-120) distributed along a length of the cylinder, with each sensor node having one or more magnetic sensors (e.g., AMR sensors). The range of movement or stroke of the piston 104 is divided into a set of ranges (subranges), and each sensor node of the sensor nodes 116-120 is configured to detect the position of the piston 104 in a particular respective range of the set of ranges.

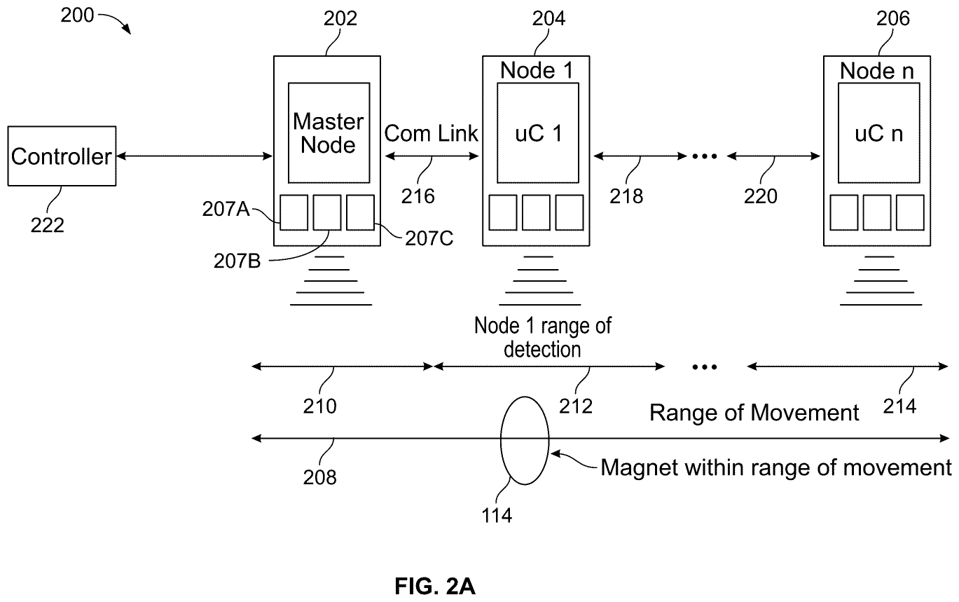

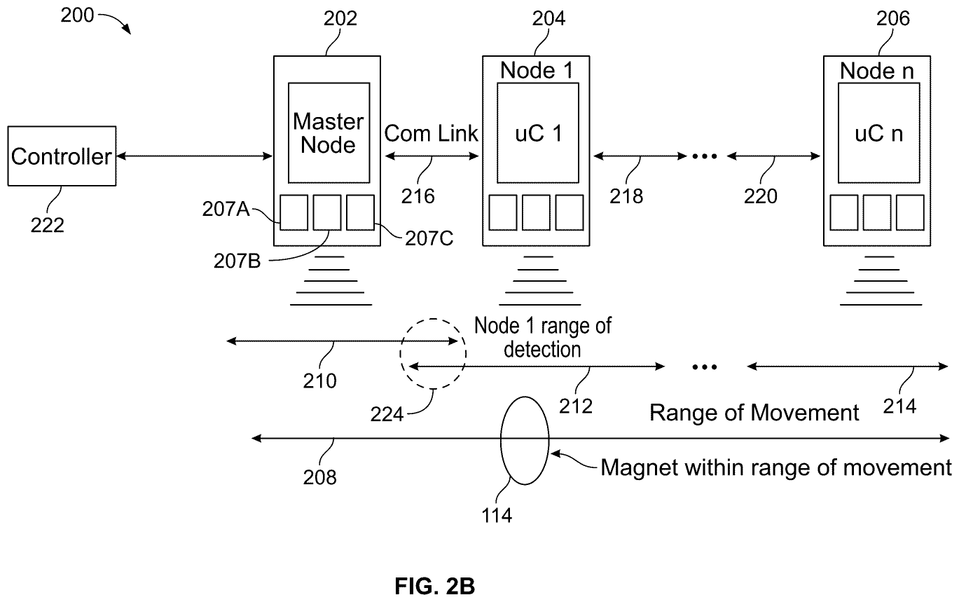

FIG. 2A is a block diagram of a PSS 200, according to an example implementation. The PSS 200 may represent the PSS of the cylinder actuator 100 described above.

In an example, the PSS 200 has a set of sensor nodes (multiple sensor nodes). One of the sensor nodes is a master sensor node, which operates to resolve the master sensor node's information and reports a position of the magnet 114 (embedded in the piston 104) within a particular assigned range of movement of the piston 104. The set of sensor nodes further include one or more subordinate sensor nodes that detect, resolve, and report position of the magnet 114 within their respective assigned position detection range.

Particularly, the PSS 200 has a master sensor node 202 which can represent any of the sensor nodes 116-120 of the cylinder actuator 100. For example, the master sensor node 202 may represent the first sensor node 116.

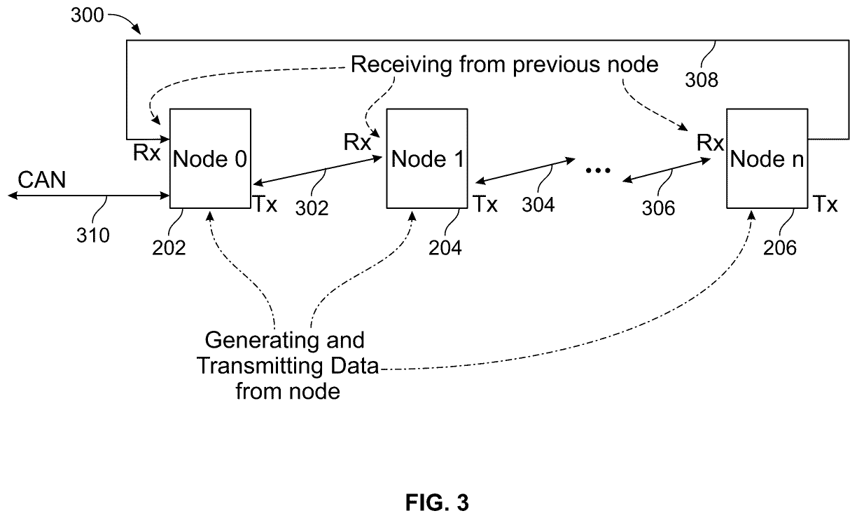

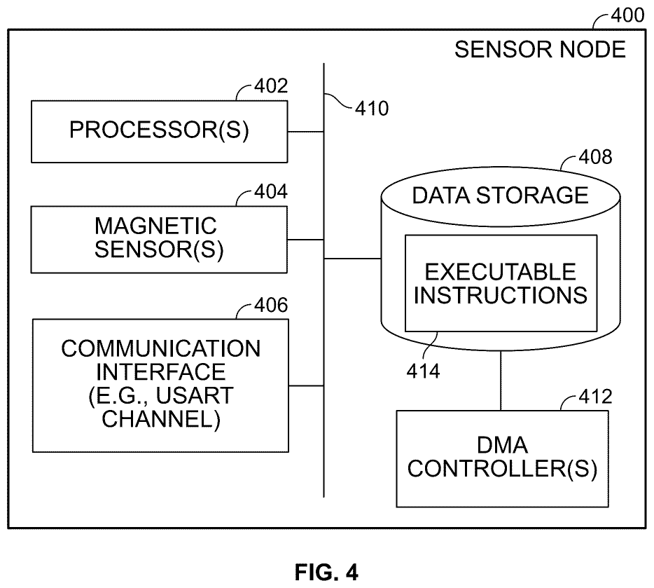

The PSS 200 also includes one or more subordinate sensor nodes based on the stroke of the piston 104. For example, if there are “n” number of sensor nodes, the PSS 200 may include a first subordinate sensor node 204, a second subordinate sensor node, etc., and an n^{th} subordinate sensor node 206. As described in more detail below with respect to FIGS. 3-4, the term “sensor node” is used herein to indicate a module having hardware, software, or a combination of hardware and software.

If the PSS 200 is the PSS of the cylinder actuator 100 where three sensor nodes are used, the master sensor node 202 may represent the first sensor node 116, the first subordinate sensor node 204 may represent the second sensor node 118, and the n^{th} subordinate sensor node 206 may represent the third sensor node 120. The sensor nodes can also be referred to as microcontrollers (μC).

In an example, each sensor node may have one or more magnetic sensors (e.g., AMR sensors/chips). For example, the master sensor node 202 may include magnetic sensor 207A, magnetic sensor 207B, and magnetic sensor 207C. The subordinate sensor nodes 204, 206 may also each have three respective magnetic sensors as depicted in FIG. 2A.

Advantageously, in this example, having multiple magnetic sensors/chips in each sensor node may provide redundancy and error mitigation. Having more than one magnetic sensor chip at each sensor node may also account for environmental conditions such as noise from the Earth's magnetic field.

The magnetic sensor chips can be mounted on one or more printed circuit boards (PCBs) in the respective sensor node. A PCB is a board may mechanically support and electrically connect electronic components (e.g., microprocessors, integrated chips, capacitors, resistors, transistors, magnetic sensor chips, communication interfaces/hardware, etc.) using conductive tracks, pads, and other features etched from one or more sheet layers of copper laminate onto and/or between sheet layers of a nonconductive substrate. Components may be soldered onto the PCB to both electrically connect and mechanically fasten them to it. Example details of a sensor node are provided below with respect to FIG. 4.

In an example, the sensor nodes (the sensor nodes 116-120 or the sensor nodes 202-206) are equi-spaced (e.g., equally-spaced apart from each other) along the cylinder 102. For example, spacing between the master sensor node 202 and the first subordinate sensor node 204 can be the same as a respective spacing between the first subordinate sensor node 204 and a subsequent sensor node. However, in other examples, the spaces might not be the same.

A full stroke or a range of movement 208 of the piston 104 can be divided into a set of ranges (subranges) of movement or ranges of detection. Each range of detection of the set of ranges is associated with a respective sensor node, which is configured to detect the position of the magnet 114 coupled to the piston head 106 when the magnet 114 is in the particular assigned range of detection of the sensor node.

For example, the master sensor node 202 is associated with a first range 210 of detection, the first subordinate sensor node 204 is associated with a second range 212 of detection, and the n subordinate sensor node 206 is associated with a third range 214 of detection, and so on. In FIG. 2A, the magnet 114 is shown in the second range 212 of detection, and thus the first subordinate sensor node 204 detects and reports its position while traversing that range. When the magnet 114 crosses to another range, another sensor node detects and reports its position. In some examples, as described below with respect to FIG. 2B, the ranges of detection may overlap, and also the range of detection of each of the magnetic sensors 207A-207C may overlap.

Thus, the PSS 200 is configured to resolve position of the magnet 114 using multiple sensor nodes, e.g., the master sensor node 202 and one or more subordinate sensor nodes (the sensor nodes 204-206). The range of movement of the piston 104 is divided into a set of ranges, one range assigned to each sensor node. Each sensor node resolves the position of the magnet 114 when the magnet 114 is within the respective assigned position detection range of the sensor node.

The number of sensors nodes may be based on the stroke length of the piston 104. For example, if the stroke length of the piston 104 is in the 6″ 8″ range, then two sensor nodes (e.g., one master sensor node and one subordinate sensor node) could be used. If the stroke length of the piston 104 is in the 10″ 12″ range, then three sensor nodes (e.g., the sensor nodes 116-118 or 202-206) could be used. If the stroke length of the piston 104 is in the 14″ 16″ range, then four sensor nodes could be used. If the stroke length of the piston 104 is in the 18″ 20″ range, then five sensor nodes could be used, and so on. Thus, each sensor node added can increase the sensing range.

As depicted in FIG. 2A, each sensor node of the “n” sensor nodes can be linked to the master sensor node 202 via respective communication link. For example, the first subordinate sensor node 204 is in communication with the master sensor node 202 via communication link 216. The sensor node that is subsequent to the first subordinate sensor node 204 is in communication with the first subordinate sensor node 204 via communication link 218, and so on, until the n^{th} sensor node communicates with the preceding sensor node via a communication link 220.

With this configuration, the sensor nodes provide position detection information to the master sensor node 202 either directly (e.g., from the first subordinate sensor node 204 to the master sensor node 202 via the communication link 216) or indirectly through other sensor nodes. In other example implementations, the sensor nodes may all be directly connected to the master sensor node 202 via respective communication links.

The master sensor node 202 thus continuously (along the entirety of the range of movement 208) and continually resolves the sensor node information provided by the other sensor nodes to determine the position of the magnet 114, which is indicative of the position of the piston 104. The master sensor node 202 may then report or provide information indicating the position of the piston 104 or the magnet 114 to a controller 222 (e.g., over a Controller Area Network (CAN) communication bus or as analog output signals with a voltage level that is representative of the position of the piston 104).

The controller 222 can be the controller of the PSS 200, the cylinder actuator 100, or the fluid system in which the cylinder actuator 100 operates. For example, the controller 222 can be configured to send command signals to a source of fluid (e.g., a pump) and/or electric actuators (e.g., solenoids or motors) of one or more valves that control fluid flow to and from the cylinder actuator 100. The controller 222 sends the command signals based on the position information indicating the position of the piston 104 to control movement of the piston 104 within the cylinder 102, the pressure levels within the chambers 110, 112, and/or the forces applied by the piston 104.

In some examples, the master sensor node 202 may be embedded in the controller 222.

Although FIG. 2A shows that the ranges are abutting and not inclusive, in some example implementations the range may overlap.

FIG. 2B is a block diagram of the position sensing system 200 with overlapping ranges of detection, according to an example implementation. As shown in FIG. 2B, the first range 210 of detection associated with the master sensor node 202 overlaps with the second range 212 of detection associated with the first subordinate sensor node at overlap region 224. In examples, each of the magnetic sensors 207A-207C may have a respective assigned range of detection that may also overlap.

In examples, the overlap region 224 may be a handoff region where two adjacent ranges overlap as the sensor nodes handoff communication and resolving position to each other. Such arrangement may make transition between the sensor nodes smooth, allowing accuracy to be maintained. As such, the use of the term “set of ranges” and reference to the full stroke of the piston 104 being divided into respective assigned ranges encompasses arrangements where the ranges overlap.

Further, in some examples, the set of ranges of detection may not be equal in length. For instance, the first range 210 of detection may be longer or shorter than the second range 212 of detection. Each range of detection for each sensor node may be configurable as desired.

FIG. 3 is a block diagram for a communication configuration 300 for the PSS 200, according to an example implementation. In the example implementation of FIG. 3, each sensor node has a respective Universal Synchronous/Asynchronous Receive Transmit (USART) channel (communication interface) dedicated to communication with one Transmission (Tx) line connected to the sequential Receive (Rx) line of the subsequent sensor node.

A Universal Synchronous Asynchronous Receiver Transmitter may be a hardware device that enables serial communication. Such receiver/transmitter can operate in two modes: (i) an Asynchronous mode, which is a slower mode that is similar to a universal asynchronous receiver/transmitter (UART), and (ii) a Synchronous mode, which is a faster mode that uses a clock signal. Such receiver/transmitter device may also be known as a Serial Communications Interface (SCI) or a Programmable Communications Interface (PCIs).

For example, the master sensor node 202 (sensor node 0) has a USART channel 302 dedicated to communication via a respective Tx line of the master sensor node 202 connected to an Rx line of the first subordinate sensor node 204. Similarly, the first subordinate sensor node 204 has a USART channel 304 dedicated to communication via a respective Tx line of the first subordinate sensor node 204 connected to an Rx line of the subsequent subordinate sensor node.

The sensor node that precedes the n^{th} subordinate sensor node 206 has a USART channel 306 dedicated to communication via a respective Tx line connected to an Rx line of the n^{th} subordinate sensor node 206. Further, the n^{th} subordinate sensor node 206 (the last sensor node) has a Tx line that is connected to the Rx line of the master sensor node 202 via communication line 308 to complete the daisy-chain circuit (e.g., circuit involving the use of a wiring method that connects multiple devices in a series to transmit signals along a bus).

Particularly, the sensor nodes may be wired or connected together in a ring arrangement. In a ring arrangement, the last or the “nth” sensor node 206 in the chain is connected back to the first or the master sensor node 202, creating a continuous loop. In an example, a flooding network protocol can be used for communication between the sensor nodes. In such network flooding protocol, an incoming data packet is sent out through every outgoing link except the one it arrived on. In a daisy-chain topology, this means a message is passed along the chain until all nodes receive it.

When the daisy-chain circuit shown in the example implementation of FIG. 3 uses a flood protocol, a message can enter the chain at any point and is then passed along to the subsequent sensor nodes until the message reaches the destination node. For instance, the first subordinate sensor node 204 may initially receive a message. Using the flooding protocol, the first subordinate sensor node 204 sends the message to its neighbor, the subsequent subordinate sensor node, and so on. Thus, the message reaches the destination sensor nodes in the chain, guaranteeing delivery even if the sender does not know where in the network the destination is, as it is in the chain.

The master sensor node 202 may then provide the position information via a communication link 310, e.g., a CAN link/bus or as an analog voltage signal, to the controller 222, for example.

Further, in an example, each sensor node may have one or more dedicated Direct Memory Access (DMA) hardware devices, features, or controllers that allow for simultaneous processing of fixed length communication messages passed between sensor nodes. The fixed length communication message contains a header frame that describes when the message starts and what the purpose of the message is, thus supporting a variable message format between sensor nodes. In a particular example, the messages being trafficked through the different USART channels may each have a header, a type of the message, a destination address (of the sensor node to which the message is being sent), a source address (of the sensor node sending the message), and the data (e.g., the position of the magnet 114 while in the respective assigned range of detection).

FIG. 4 is a block diagram of a sensor node 400, according to an example implementation. The sensor node 400 can represent, or can be included in, any of the sensor nodes described above with respect to FIGS. 1-3 (e.g., any of the sensor nodes 116-118 or the sensor nodes 202-206).

The sensor node 400 may have processor(s) 402, one or more magnetic sensor(s) 404 (e.g., AMR sensors as described above), a communication interface 406, and data storage 408, each connected to a communication bus 410. The sensor node 400 may also have one or more DMA controller(s) 412. Components of the sensor node 400 may all be mounted to a PCT as described above.

The communication interface 406 of the sensor node 400 may also include hardware to enable communication within the sensor node 400, and between the sensor node 400 and other devices or sensor nodes. For example, the communication interface may enable communicating with a communication bus of the PSS in which the sensor node 400 is used, or a communication bus of a system in which the PSS or the sensor node 400 is deployed such as a CAN bus of a vehicle or machine.

The hardware of the communication interface 406 may include transmitters, receivers, and antennas, for example. For instance, the communication interface 406 may include USART channels as communication links between the sensor nodes as discussed above with respect to FIGS. 2-3.

In example, the communication interface 406 may be a wireless interface and/or one or more wireline interfaces that allow for both short-range communication and long-range communication to one or more networks or other devices (e.g., to allow communication with other sensor nodes or with the controller 222). Such wireless interfaces may provide for communication under one or more wireless communication protocols, Bluetooth, Wi-Fi (e.g., an institute of electrical and electronic engineers (IEEE) 802.11 protocol), Long-Term Evolution (LTE), cellular communications, near-field communication (NFC), and/or other wireless communication protocols.

Wireline interfaces may include an Ethernet interface, a CAN network interface, a USB interface, or similar interface to communicate via a wire, a twisted pair of wires, a coaxial cable, an optical link, a fiber-optic link, or other physical connection to a wireline network. Thus, the communication interface 406 may be configured to receive input data from other sensor nodes and, and may be configured to send output data to other sensor nodes or the controller 222 and perform the operations described herein.

The data storage 408 is the main memory of the sensor node 400 and may include or take the form of one or more computer-readable storage media that can be read or accessed by the processor(s) 402. The computer-readable storage media can include volatile and/or non-volatile storage components, such as optical, magnetic, organic or other memory or disc storage, which can be integrated in whole or in part with the processor(s) 402.

The data storage 408 is considered non-transitory computer readable media. In some examples, the data storage 408 can be implemented using a single physical device (e.g., one optical, magnetic, organic or other memory or disc storage unit), while in other examples, the data storage 408 can be implemented using two or more physical devices.

The data storage 408 thus is a non-transitory computer readable storage medium, and executable instructions 414 are stored thereon. The executable instructions 414 include computer executable code. When the executable instructions 414 are executed by the processor(s) 402, the processor(s) 402 are caused to perform operations of the sensor node 400 described herein (e.g., operations associated with determining changes in magnetic field direction or intensity as sensed by the magnetic sensor(s) 404, determining a position of the magnet 114 and the piston 104 when the piston 104 and the magnet 114 are in the particular assigned range of the sensor node 400, sending the position information to a subsequent sensor node, etc.).

The processor(s) 402 may be a general-purpose processor or a special purpose processor (e.g., digital signal processors, application-specific integrated circuits (ASIC), etc.). The processor(s) 402 may receive inputs from the communication interface 406, the communication bus 410, or directly from other components such as the magnetic sensor(s) 404. The processor(s) 402 then process the inputs to generate outputs (e.g., position of the magnet 114 and the piston 104). The processor(s) 402 can be configured to execute the executable instructions 414 (e.g., computer-readable program instructions) that are stored in the data storage 408 and are executable to provide the functionality of the sensor node 400 described herein.

The DMA controller(s) 412 are in communication with the data storage 408 of the sensor node 400. The DMA controller(s) 412 may be computer hardware features that allows accessing the data storage 408 directly, bypassing the processor(s) 402.

Particularly, the DMA controller(s) 412 can offload data transfer tasks from the processor(s) 402, reducing processor overhead and improving performance and responsiveness of the sensor node 400. As such, the DMA controller(s) 412 enable high-speed data processing, such as moving large blocks of data between the sensor nodes, or between different locations in the data storage 408.

In an example, the DMA controller(s) 412 may include two DMA controllers to allow every sensor node in the PSS to transmit and receive traffic data without loading the processor(s) 402 with communications burdens. Particularly, one DMA controller may be associated with receiving data from another sensor node, while another DMA controller may be associated with transmitting data to another sensor node.

As an example, if the sensor node 400 needs to transfer position data to another sensor node or to the controller 222, a DMA controller from the DMA controller(s) 412 can be configured to handle the data transfer. The processor(s) 402 set up the DMA controller(s) 412 to move data between the data storage 408 and the communication interface 406, which interfaces with the communication bus 410. Once configured, the DMA controller(s) 412 are able to transfer the data between the data storage 408 and the communication interface 406, without further intervention from the processor(s) 402. This approach offloads the data transfer workload from the processor(s) 402, allowing it to perform other tasks. Similarly, a DMA controller can be used to receive data from other sensor nodes by transferring incoming data directly from the communication interface 406 to the data storage 408.

The controller 222 may include similar components such as one or more processors, communication interface, data storage with executable instructions stored thereon, DMA controllers, etc.

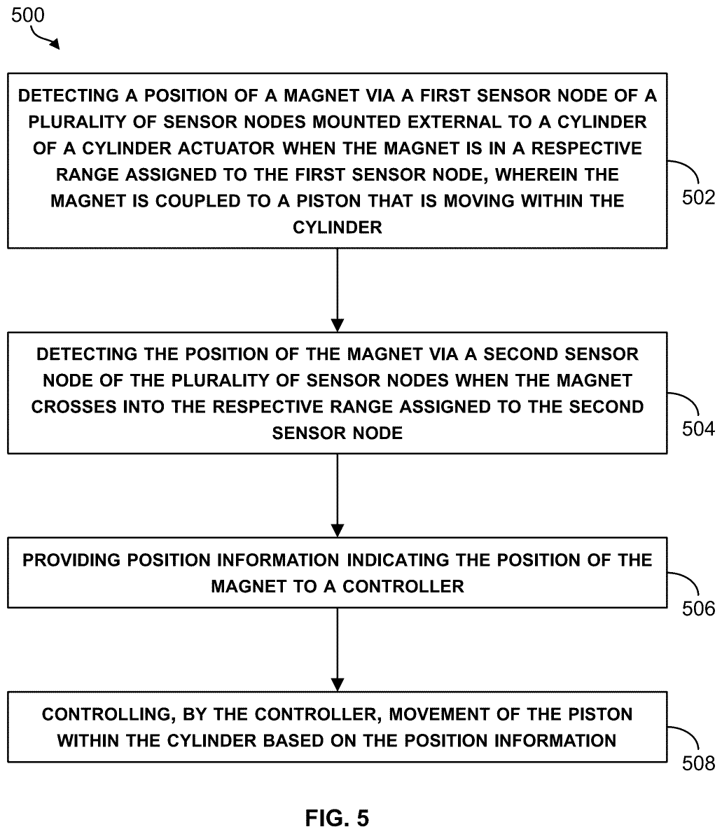

FIG. 5 is a flowchart of a method 500 for operating a position sensing system or a cylinder actuator 100, according to an example implementation. The method 500 can be implemented to operate the PSS 200 and/or the cylinder actuator 100, for example.

The method 500 may include one or more operations, or actions as illustrated by one or more of blocks 502-508. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 500 and other processes and operations disclosed herein, the flowchart shows operation of one possible implementation of present examples. In this regard, each block may represent a module, a segment, or a portion of program code, which includes one or more instructions executable by a processor (e.g., the processor(s) 402 of the sensor node 400) for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 500 and other processes and operations disclosed herein, one or more blocks in FIG. 5 may represent circuitry or digital logic that is arranged to perform the specific logical operations in the process.

At block 502, the method 500 includes detecting a position of the magnet 114 via a first sensor node (e.g., the sensor node 116 or the master sensor node 202) of a plurality of sensor nodes mounted external to the cylinder 102 of the cylinder actuator 100 when the magnet 114 is in a respective range (e.g., the first range 210) assigned to the first sensor node, wherein the magnet 114 is coupled to the piston 104 that is moving within the cylinder 102.

At block 504, the method 500 includes detecting the position of the magnet 114 via a second sensor node (e.g., the second sensor node 118 or the first subordinate sensor node 204) of the plurality of sensor nodes when the magnet 114 crosses into the respective range (e.g., the second range 212) assigned to the second sensor node.

At block 506, the method 500 includes providing position information indicating the position of the magnet 114 to the controller 222.

At block 508, the method 500 includes controlling, by the controller 222, movement of the piston 104 within the cylinder 102 based on the position information.

The method 500 can further include any of the steps performed by the PSS 200 or the devices thereof as described throughout herein.

Although the description above with respect FIGS. 1-3, 5 relates to having the magnet 114 embedded in the piston 104 and movable therewith, while the sensor nodes 116-120 (or the sensor nodes 202-206) are stationary, in other examples, one or more sensor modes may be movable relative to a source of magnetic field that is fixed. The one or more sensor nodes can determine their position based on detecting changes in the magnetic field as the one or more sensor nodes move relative to the source of magnetic field.

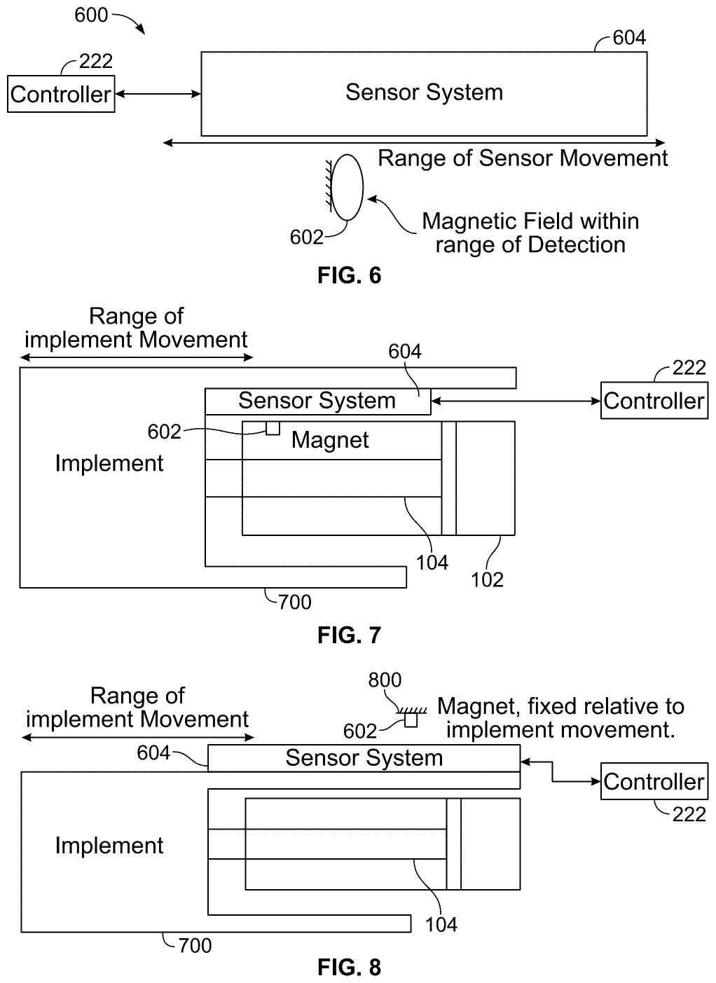

FIG. 6 is a block diagram of a PSS 600 having a fixed source 602 of magnetic field and a movable sensor system 604, according to an example implementation. In the PSS 600, the source 602 of magnetic field can be a magnet (e.g., permanent or electromagnet) that is fixed. For instance, the source 602 can be mounted external or internal to the cylinder 102 of the cylinder actuator 100 or mounted to any fixed surface of a machine in which the cylinder actuator 100 is used.

The sensor system 604 can have one or more sensor nodes such as any of the sensor nodes described above. The sensor system 604, however, can be coupled to the piston 104, directly or indirectly, and is thus movable therewith.

As such, the sensor system 604 is movable relative to the source 602. With this configuration, and given that the characteristics of the magnetic field generated by the source 602 may be known, the sensor system 6004 can provide information indicative of its position (and thus the position of the piston 104). The PSS 600 can be implemented in various ways.

FIG. 7 illustrates the cylinder actuator 100 driving an implement 700 with the sensor system 604 coupled to the implement 700, according to an example implementation. In FIG. 7, the sensor system 604 is mounted on an interior surface of the implement 700, which is coupled to and movable with the piston 104. The source 602 (e.g., a magnet similar to the magnet 114) is coupled or attached to an interior surface of the cylinder 102. In other examples, the source 602 can be mounted external the cylinder 102.

Thus, the source 602 is fixed, while the sensor system 604 is movable with the piston 104 and the implement 700. As the implement 700 moves, the sensor system 604 detects a change in characteristics of the magnetic field generated by the source 602, and may thus provide information indicative of such change, which is also indicative of a position of the sensor system 604, the implement 700, and the piston 104.

In other examples, the source 602 can be mounted external to the cylinder actuator 100. For example, the source 602 can be coupled to any fixed portion of a machine that includes the cylinder actuator 100.

FIG. 8 illustrates the cylinder actuator 100 driving the implement 700 with the sensor system 604 coupled to the implement 700 and the source 602 disposed external the cylinder actuator 100, according to an example implementation. In the example implementation of FIG. 8, the sensor system 604 is mounted to an external surface of the implement 700 to face the source 602, which is fixedly attached to a surface 800 of a machine, for example.

Thus, similar to the implementation of FIG. 7, the source 602 is fixed, while the sensor system 604 is movable with the piston 104 and the implement 700. As the implement 700 moves, the sensor system 604 detects a change in characteristics of the magnetic field generated by the source 602, and may thus provide information indicative of such change, which is also indicative of a position of the sensor system 604, the implement 700, and the piston 104.

As such, detection of the position of the piston 104 may generally involve movement of a magnetic field relative to at least one sensor node. In examples (e.g., FIGS. 1, 2A-2B), the source of magnetic field may be movable, while the at least one sensor node is fixed. In other example implementations (e.g., FIGS. 6-8), the source of magnetic field is fixed, while the at least one sensor node is movable. In both cases, relative movement between the magnetic field and the sensor node results in changes to the magnetic field as detected by the sensor node, and a position of the sensor node relative to the source of magnetic field can be determined based on quantifying such changes.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform actuators presented in the figures. In some instances, components of the devices and/or systems may be configured to perform the actuators such that the components are actually configured and structured (with hardware and/or software) to enable such performance. In other examples, components of the devices and/or systems may be arranged to be adapted to, capable of, or suited for performing the actuators, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a position sensing system comprising: a cylinder actuator having a cylinder and a piston that is movable within the cylinder, wherein a range of movement of the piston is divided into a set of ranges of detection; a magnet that is coupled to the piston; and a plurality of sensor nodes mounted external to the cylinder, wherein each sensor node of the plurality of sensor nodes is assigned a respective range of detection of the set of ranges of detection, and wherein each sensor node provides position information indicating a position of the magnet when the magnet is in the respective range of detection assigned to the sensor node.

EEE 2 is the position sensing system of EEE 1, wherein the plurality of sensor nodes are spaced apart along at least a portion of a length of the cylinder.

EEE 3 is the position sensing system of any of EEEs 1-2, wherein the plurality of sensor nodes comprise: one or more subordinate sensor nodes, each subordinate sensor node being configured to detect the position of the magnet and provides the position information when the magnet is within the respective range of detection assigned to the subordinate sensor node; and a master sensor node that is in communication with the one or more subordinate sensor nodes, wherein the master sensor node (i) detects the position of the magnet and provides the position information when the magnet is within the respective range of detection assigned to the master sensor node, (ii) receives the position information from the one or more subordinate sensor nodes, and (iii) provides the position information to a controller.

EEE 4 is the position sensing system of any of EEEs 1-3, wherein each sensor node of the plurality of sensor nodes has a respective Universal Synchronous/Asynchronous Receive Transmit (USART) channel dedicated to communication with one Transmission (Tx) line connected to a Receive (Rx) line of a subsequent sensor node.

EEE 5 is the position sensing system of any of EEEs 1-4, wherein a last sensor node of the plurality of nodes has a Tx line that is connected to a first sensor node of the plurality of sensor nodes via a communication line to complete a daisy-chain circuit.

EEE 6 is the position sensing system of EEE 5, wherein the plurality of sensor nodes communicate using a network flooding protocol to distribute the position information.

EEE 7 is the position sensing system of any of EEEs 1-6, wherein each sensor node has a processor and at least one dedicated Direct Memory Access (DMA) controller, wherein the at least one DMA controller allows for communicating the position information with no or minimal involvement of the processor.

EEE 8 is the position sensing system of EEE 7, wherein the at least one DMA controller comprise: a first DMA controller for receiving the position information from a preceding sensor node; and a second DMA controller for transmitting the position information to a subsequent sensor node.

EEE 9 the position sensing system of any of EEEs 1-8, wherein each sensor node includes one or more magnetic sensors configured to detect the position of the magnet.

EEE 10 is the position sensing system of EEE 9, wherein a magnetic sensor of the one or more magnetic sensors is an anisotropic magnetoresistive sensor.

EEE 11 is the position sensing system of any of EEEs 1-10, wherein the magnet is embedded in the piston.

EEE 12 is the position sensing system of any of EEEs 1-11, wherein the piston has a piston head and a piston rod extending from the piston head along a central longitudinal axis of the cylinder, and wherein the magnet is embedded in the piston head.

EEE 13 is a method of operating the position sensing system or the cylinder actuator of any of EEEs 1-12. For example, the method comprises: detecting a position of a magnet via a first sensor node of a plurality of sensor nodes mounted external to a cylinder of a cylinder actuator when the magnet is in a respective range of detection assigned to the first sensor node, wherein the magnet is coupled to a piston that is moving within the cylinder; detecting the position of the magnet via a second sensor node of the plurality of sensor nodes when the magnet crosses into the respective range of detection assigned to the second sensor node; providing position information indicating the position of the magnet to a controller; and controlling, by the controller, movement of the piston within the cylinder based on the position information.

EEE 14 is the method of EEE 13, wherein providing the position information indicating the position of the magnet to the controller comprises: providing the position information to a master sensor node of the plurality of sensor nodes; and providing the position information via the master sensor node to the controller.

EEE 15 is the method of any of EEEs 13-14, further comprising: providing the position information via a Transmission (Tx) line of a Universal Synchronous/Asynchronous Receive Transmit (USART) channel of the first sensor node to an Receive (Rx) line of a respective USART channel of the second sensor node.

EEE 16 is the method of EEE 15, wherein the plurality of sensor nodes comprise a master sensor node, and wherein providing the position information comprises: providing the position information via a Transmission (Tx) line of the respective USART channel of the second sensor node to a respective Receive (Rx) line of the master sensor node to complete a daisy-chain circuit.

EEE 17 is the method of any of EEEs 13-16, wherein each sensor node has a processor and at least one dedicated Direct Memory Access (DMA) controller, and wherein providing the position information comprises: using the at least one DMA controller to communicate the position information with no or minimal involvement of the processor.

EEE 18 is the method of EEE 17, wherein using the at least one DMA controller to communicate the position information comprises: using a first DMA controller of the second sensor node to receive the position information from the first sensor node; and using a second DMA controller of the second sensor node to transmit the position information to a subsequent sensor node.

EEE 19 is the method of any of EEEs 13-18, wherein detecting the position of the magnet comprises: detecting the position of the magnet via one or more magnetic sensors included in a respective sensor node.

EEE 20 is the method of EEE 19, wherein detecting the position of the magnet via the one or more magnetic sensors comprises: detecting the position of the magnet via one or more anisotropic magnetoresistive sensors.

EEE 21 is the position sensing system of any of EEEs 1-12 or the method of any of EEEs 13-20, wherein the set of ranges of detection overlap with each other.

EEE 22 is a position sensing system comprising: a cylinder actuator having a cylinder and a piston that is movable within the cylinder; a source of magnetic field; and at least one sensor node (e.g., any of the sensor nodes of EEEs 1-21) mounted to the piston and movable therewith, wherein the at least one sensor node provides position information indicating a position of the piston based on movement of the at least one sensor node relative to the source of magnetic field.

What is claimed is:

1. A position sensing system comprising:
a cylinder actuator having a cylinder and a piston that is movable within the cylinder, wherein a range of movement of the piston is divided into a set of ranges of detection;
a magnet that is coupled to the piston; and
a plurality of sensor nodes mounted external to the cylinder, wherein each sensor node of the plurality of sensor nodes is assigned a respective range of detection the set of ranges of detection, and wherein each sensor node provides position information indicating a position of the magnet when the magnet is in the respective range of detection assigned to the sensor node.

2. The position sensing system of claim 1, wherein the plurality of sensor nodes are spaced apart along at least a portion of a length of the cylinder.

3. The position sensing system of claim 1, wherein the plurality of sensor nodes comprise:
one or more subordinate sensor nodes, each subordinate sensor node being configured to detect the position of the magnet and provides the position information when the magnet is within the respective range of detection assigned to the subordinate sensor node; and
a master sensor node that is in communication with the one or more subordinate sensor nodes, wherein the master sensor node (i) detects the position of the magnet and provides the position information when the magnet is within the respective range of detection assigned to the master sensor node, (ii) receives the position information from the one or more subordinate sensor nodes, and (iii) provides the position information to a controller.

4. The position sensing system of claim 1, wherein each sensor node of the plurality of sensor nodes has a respective Universal Synchronous/Asynchronous Receive Transmit (USART) channel dedicated to communication with one Transmission (Tx) line connected to a Receive (Rx) line of a subsequent sensor node.

5. The position sensing system of claim 1, wherein a last sensor node of the plurality of nodes has a Tx line that is connected to a first sensor node of the plurality of sensor nodes via a communication line to complete a daisy-chain circuit.

6. The position sensing system of claim 5, wherein the plurality of sensor nodes communicate using a network flooding protocol to distribute the position information.

7. The position sensing system of claim 1, wherein each sensor node has a processor and at least one dedicated Direct Memory Access (DMA) controller, wherein the at least one DMA controller allows for communicating the position information with no or minimal involvement of the processor.

8. The position sensing system of claim 7, wherein the at least one DMA controller comprise:
a first DMA controller for receiving the position information from a preceding sensor node; and
a second DMA controller for transmitting the position information to a subsequent sensor node.

9. The position sensing system of claim 1, wherein each sensor node includes one or more magnetic sensors configured to detect the position of the magnet.

10. The position sensing system of claim 9, wherein a magnetic sensor of the one or more magnetic sensors is an anisotropic magnetoresistive sensor.

11. The position sensing system of claim 1, wherein the magnet is embedded in the piston.

12. The position sensing system of claim 1, wherein the piston has a piston head and a piston rod extending from the piston head along a central longitudinal axis of the cylinder, and wherein the magnet is embedded in the piston head.

13. A method comprising:
detecting a position of a magnet via a first sensor node of a plurality of sensor nodes mounted external to a cylinder of a cylinder actuator when the magnet is in a respective range of detection assigned to the first sensor node, wherein the magnet is coupled to a piston that is moving within the cylinder;
detecting the position of the magnet via a second sensor node of the plurality of sensor nodes when the magnet crosses into the respective range of detection assigned to the second sensor node;
providing position information indicating the position of the magnet to a controller; and
controlling, by the controller, movement of the piston within the cylinder based on the position information.

14. The method of claim 13, wherein providing the position information indicating the position of the magnet to the controller comprises:
providing the position information to a master sensor node of the plurality of sensor nodes; and
providing the position information via the master sensor node to the controller.

15. The method of claim 13, further comprising:
providing the position information via a Transmission (Tx) line of a Universal Synchronous/Asynchronous Receive Transmit (USART) channel of the first sensor node to an Receive (Rx) line of a respective USART channel of the second sensor node.

16. The method of claim 15, wherein the plurality of sensor nodes comprise a master sensor node, and wherein providing the position information comprises:
providing the position information via a Transmission (Tx) line of the respective USART channel of the second sensor node to a respective Receive (Rx) line of the master sensor node to complete a daisy-chain circuit.

17. The method of claim 13, wherein each sensor node has a processor and at least one dedicated Direct Memory Access (DMA) controller, and wherein providing the position information comprises:
using the at least one DMA controller to communicate the position information with no or minimal involvement of the processor.

18. The method of claim 17, wherein using the at least one DMA controller to communicate the position information comprises:
using a first DMA controller of the second sensor node to receive the position information from the first sensor node; and
using a second DMA controller of the second sensor node to transmit the position information to a subsequent sensor node.

19. The method of claim 13, wherein detecting the position of the magnet comprises:
detecting the position of the magnet via one or more magnetic sensors included in a respective sensor node.

20. The method of claim 19, wherein detecting the position of the magnet via the one or more magnetic sensors comprises:
detecting the position of the magnet via one or more anisotropic magnetoresistive sensors.
